(19) United States
(12) Patent Application Publication
(10) Pub. No.: US 2003/0218136 A1
(43) Pub. Date: Nov. 27, 2003

(54) Ultraviolet water treatment apparatus

(76) Inventor: James L. Anderson, Fargo, ND (US)

Correspondence Address: Wayne A. Sivertson, NAWROCKI, ROONEY & SIVERTSON, P.A., Broadway Place East, Suite 401, 3433 Broadway Street Northeast, Minneapolis, MN, 55413, US

(21) Appl. No.: 10/155,366

(22) Filed: May 23, 2002

(51) Int. Cl. C02F 1/32

(52) U.S. Cl. 250/436

(57) ABSTRACT

An apparatus for treating water through the use of UV radiation including an elongate housing having two ends and an internal cavity formed therein. The housing includes an inlet orifice and an outlet orifice both in fluid communication with the cavity. A fluid flow path having a central axis is formed between the inlet orifice and outlet orifice. A plurality of UV radiation sources are positioned in proximity to the central axis of the fluid flow path in its elongate dimension.

### BACKGROUND OF THE INVENTION

The present invention relates generally to the field of water treatment. In particular, the present invention involves an apparatus for the treatment of water through the use of ultraviolet light.

It has been recognized that ultraviolet light can be utilized to kill bacteria in water. Devices have been developed to perform this function. However, the prior art devices have several drawbacks. For example, known devices are designed having inlets and outlets that are restricted—both by the diameter of the inlet and outlet connections and by bends in the connections. Each of these features result in a flow restriction.

The described devices also tend to have flow restrictions within the body of the device wherein the water being treated is redirected in one or more directions. These changes in direction either direct the water past the ultraviolet source more than once, or churn the water within the device to pass more water in close proximity to the source of the ultraviolet radiation (UV). However, the directional changes typically also act to restrict the passage of the water through the device. This is particularly problematic for applications wherein a constant, high outlet volume of water is desired.

Additionally, traditional devices utilize a single UV source, preferably located in the center of the cavity in which the water is to be treated. Placing the source in the center of the device prevents the use of a straight fluid flow path through the device. The use of a single UV source in the center of the device also limits the amount of water that can be treated in that close proximity to the UV source is necessary for treatment.

### SUMMARY OF THE INVENTION

The present invention provides a device that can provide a constant, high volume output of treated water. The device also provides a generally straight flow path through the device without substantial flow restriction. This direct flow path through the device allows water to pass through the inlet and outlet of the device at a higher rate.

One embodiment of an apparatus in accordance with the present invention includes an elongate housing having two ends and an internal cavity formed therein. The housing includes an inlet orifice and an outlet orifice both in fluid communication with the cavity. A fluid flow path is formed through the cavity between the inlet orifice and outlet orifice. The fluid flow path has a central flow axis. A plurality of UV radiation sources are positioned around the central axis of the fluid flow path in its elongate dimension. The apparatus may be constructed having an inlet orifice on one end of the housing and an outlet orifice on the other end of the housing. The apparatus may also have an interior housing surface formed with a reflective coating thereon.

The aforementioned benefits and other benefits including specific features of the invention will become clear from the following description by reference to the accompanying drawings.

### BRIEF DESCRIPTION OF THE DRAWINGS

FIG. 1 is an angled overhead view of one embodiment of the present invention;

FIG. 2 is a cut-away side view of the embodiment of FIG. 1;

FIG. 3 is a segmented view of the embodiment of FIG. 2 of the portion indicated in FIG. 2; and

FIG. 4 is a segmented side view of the embodiment of FIG. 2 taken of the portion indicated in FIG. 2.

### DETAILED DESCRIPTION OF THE INVENTION

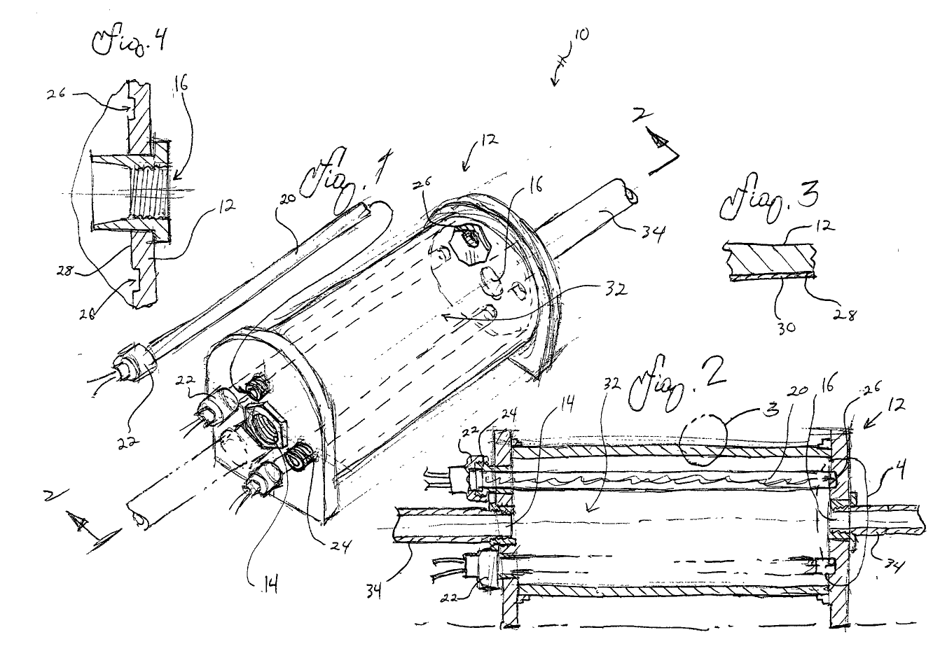

Referring now to the drawings, wherein like reference numerals denote like elements throughout the several views, FIG. 1 illustrates a transparent angled top view of an embodiment of the present invention.

The embodiment shown in FIG. 1, generally comprises a housing 12 having a lumen extending through the housing, or alternatively, having an internal cavity 32 formed in the housing 12 and an inlet orifice 14 and an outlet orifice 16 in fluid communication with the cavity. The apparatus is preferably attached in-line to a water line 34 such that the water flows, from the line 34, into the apparatus 10. Any suitable means of attachment to a water line may be utilized. The housing 12 is constructed and arranged to house several UV sources 20 within the housing 12 and more preferably, within the cavity 32 formed therein.

The interior surface of the housing 12 forms a hollow cavity 32 having an elongate dimension, comprised of one or more walls, and two or more end surfaces. The cavity is preferably a generally cylindrical shape. However, any suitable shape known in the art may be utilized. The cavity 32, in combination with the inlet orifice 14 and the outlet orifice 16, form a fluid flow path through the device. The fluid flow path has a control axis defined therein. In effect, the cavity 32 and the inlet and outlet orifices 14 and 16 provide a lumen that extends through the housing, for the propagation of fluid therethrough. It is preferred that the flow path is as straight as practicable although other configurations may be utilized. Accordingly, in the embodiment shown, the centers of the inlet and outlet orifices 14 and 16 are aligned along the longitudinal central axis of the housing 12 and thereby providing a straight flow path through the apparatus with the control axis of the flow path aligned with the central axis of the housing.

In the embodiment shown in the figures, the housing 12 is designed such that the UV sources 20 are positioned around the central axis of the fluid flow path in its elongate direction. The housing 12 may have a diameter such that the flow path is the same size as, or larger than, the diameter of one or both of the orifices. If the inlet and outlet orifices are aligned with the flow path, it may also be said that the UV sources are oriented around the inlet orifice 14 and outlet orifice 16 of the housing 12. Any suitable size and shape UV source may be utilized. For example, the UV sources may be elongated to extend along the interior of the cavity in the elongate direction (in the direction of the longitudinal axis of the housing 12) as shown in the figures. If elongate UV sources are utilized, it is also preferred that the UV sources are oriented generally parallel to and spaced generally equidistant from the central axis of the fluid flow path. This central flow path axis may coincide with the central axis of the housing 12. It is also preferred that the UV sources are equally spaced apart around the central axis of the fluid flow path. In this way, each source provides a generally equal amount of radiation over the length of the cavity.

As the embodiment shown in the figures illustrates, the UV sources may be a plurality of elongate UV light bulbs 20. The number of UV sources may be as many as is necessary to treat the amount of water being moved through the apparatus. For example, as shown in FIGS. 1 and 2, four UV sources 20 are utilized.

Additionally, any method of maintaining or fixing the UV sources in position may be utilized. One such means of maintaining the UV sources in position, as shown in FIGS. 1 and 2, provides internally threaded fixtures 22 mounted near one end of the source 20 for attachment to externally threaded lugs 24 provided on one end of the housing 12. The connection between the internally threaded fixtures 22 and lugs 24 should be water tight. The lugs 24 preferably have a single lumen therethrough that provides access to the interior space of the housing 12 while sealing the housing interior. The lumen is preferably sized to accommodate one end of one of the UV sources 20. On the interior surface of the opposing end of the housing 12, it is preferred that the housing 12 has one or more recesses 26 formed therein to accommodate and support the end of one of the plurality of UV sources 20.

Additionally, if desired, the interior surface 28 of the housing 12 may be coated with a reflective material 30. Any suitable reflective material may be utilized. One example of a suitable reflective material is aluminum. This structure enables the interior surface of the housing 12 to act as a mirror to reflect the radiation back through the water, rather than to absorb the radiation. This allows the radiation to continue to interact with the water, thereby increasing the effect of the radiation on the water being treated.

The apparatus is particularly suitable for constant, high output applications, such as pool or pond filtration, and the like, however, the apparatus may be utilized for any application in which it would be useful.

Since many possible embodiments may be made of the present invention without departing from the scope thereof, it is to be understood that all matter herein set forth or shown in the accompanying figures is to be interpreted in the illustrative and not limiting sense.

What is claimed is:

1. Apparatus for treating water through the use of UV radiation, comprising:
an elongate housing having two ends and an internal cavity formed therein along an elongate central axis, said housing including an inlet orifice and an outlet orifice both in fluid communication with said cavity wherein a fluid flow path is formed between said inlet orifice and said outlet orifice along said central axis; and
a plurality of UV radiation sources in proximity to said central axis of said fluid flow path.

2. The apparatus according to claim 1, wherein said plurality of UV radiation sources are positioned around said central axis of said fluid flow path in its elongate dimension.

3. The apparatus according to claim 1, wherein said inlet orifice is located on one end of said housing and said outlet orifice is located on said other end of said housing.

4. The apparatus according to claim 1, wherein said inlet and outlet are oriented along the central axis of said housing.

5. The apparatus according to claim 1, wherein said plurality of UV sources are oriented generally parallel to and spaced generally equidistantly from said central axis of said fluid flow path.

6. The apparatus according to claim 1, wherein said UV sources have an elongate length such that they extend at least the length of said interior cavity.

7. The apparatus according to claim 1, wherein said cavity has a generally cylindrical shape.

8. The apparatus according to claim 1, wherein said housing has an interior surface forming said cavity and wherein said interior surface has a reflective coating thereon.

9. The apparatus according to claim 1, wherein said UV sources are elongate light bulbs.

10. The apparatus according to claim 1, wherein said housing has an interior surface forming said cavity, and said UV sources have two ends, and wherein a recess is formed in the interior surface of one of said ends of said housing to accommodate the end of a UV source.

11. The apparatus according to claim 1, wherein said housing has an interior surface forming said cavity, and said UV sources have two ends, and wherein at least one lumen is formed, through one of said ends of said housing, said lumen sized to accommodate of one of said UV sources.

12. The apparatus according to claim 1, wherein said inlet orifice has a diameter and said cavity of said housing has a diameter larger than the diameter of said inlet orifice.

13. The apparatus according to claim 1, wherein said outlet orifice has a diameter and said cavity of said housing has a diameter larger than said outlet orifice.

14. The apparatus according to claim 1, wherein said plurality of UV sources is more than two.

15. The apparatus according to claim 1, wherein said inlet and outlet orifices are oriented along the central axis of said housing and said plurality of UV sources are arranged generally parallel to and spaced generally equidistantly from said central axis.

16. The apparatus according to claim 4, wherein said UV sources have an elongate length and wherein the elongate length of said sources is aligned with said central axis of said fluid flow path.

17. The apparatus according to claim 1, wherein said fluid flow path is straight between said inlet and outlet orifices.

18. Apparatus for treating water through the use of UV radiation, comprising:
a cylindrical housing having an elongate length and two ends, defining the dimension of the housing in the elongated direction, said housing having an interior surface forming an internal cavity therein, said housing having a central axis in the elongate direction, said ends each having an orifice therein in fluid communication with said cavity; and
a plurality of UV radiation sources positioned around said orifices.

19. The apparatus according to claim 18, wherein said ends are aligned parallel to each other.

20. The apparatus according to claim 18, wherein said orifices each have a diameter and said cavity of said housing has a diameter larger than at least one of the diameters of said orifices.

21. Apparatus for treating water through the use of UV radiation and straight flow through the apparatus, comprising:
a housing having a lumen therethrough for transferring fluid, said lumen defining a fluid flow path having a central axis and said housing having an inlet and an outlet with said fluid flow path extending between said inlet to said outlet, said lumen having a plurality of UV radiation sources aligned generally parallel to and spaced generally equidistant to said central axis of said fluid flow path.
